(19) United States
(12) Patent Application Publication
(10) Pub. No.: US 2007/0236757 A1
(43) Pub. Date: Oct. 11, 2007

(54) Rich color image processing method and apparatus

(76) Inventors: Duncan Stewart, Palo Alto, CA (US); Shih-Yuan Wang, Palo Alto, CA (US); Philip J. Kuekes, Palo Alto, CA (US); Alexandre M. Bratkovski, Palo Alto, CA (US); R. Stanley Williams, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/402,154

(22) Filed: Apr. 10, 2006

(51) Int. Cl. H04N 1/46

(52) U.S. Cl. 358/509; 358/506

(57) ABSTRACT

Techniques for rich color image processing are disclosed. The techniques include using an array of tunable optical filter elements to define pixels of an image. The tunable optical filter elements are tuned over a range of optical frequencies to control the color filtering of the individual pixels. Exemplary embodiments for image capture and projection are illustrated.

### FIELD OF THE INVENTION

The present invention relates generally to optical image processing. More particularly, the present invention relates to capture, encoding, display and projection of rich color images using a plurality of tunable optical filters to define an array of individual pixels.

### BACKGROUND

We live in a color world, and seek to reproduce that color in paintings, photographs, television images, digital images, and the like. In nature, colors are determined by object's reflective properties as a function of optical frequency. For example, objects which reflect light at long wavelengths of about 650 nm appear reddish, while objects which reflect light at shorter wavelengths of about 475 nm appear bluish. In nature, the perceived color of an object depends on a combination of the spectral characteristics of the illuminating light source and the reflective properties of the object. Light sources can have complex spectrums, including energy emission over continuous ranges of optical frequency (e.g., incandescent white light), energy at a primarily single frequency (e.g., a laser), energy at several primarily discrete frequencies (e.g., a low pressure sodium vapor light), or a combination of continuous and discrete energy spectrums. Perceived colors are therefore also affected by the type of lighting in which they are viewed. For example, it is known that sodium vapor streetlights cause significant color distortion due to the limited line spectrum emitted. Some digital cameras attempt to compensate for different lighting conditions by mathematically transforming captured data to simulate illumination by white light.

The human eye detects colors via cone cells. Color sensitivity is provided by three different types of cone cells, the so-called short, medium, and long wavelength sensitive cells. Peak sensitivity of the cone cells corresponds roughly to blue, green, and red wavelengths of light.

Color images are typically encoded in a red-green-blue (RGB) color system. The RGB wavelengths are chosen to approximate the sensitivity of the cones in the human eye. Hence, a combination of three monochromatic light sources in the RGB system can theoretically simulate visible monochromatic light of any wavelength to a human observer.

Images are typically broken into a number of small elements known as pixels for transmission (e.g., in television) or storage (e.g., in digital imaging). Each pixel typically contain three color components, corresponding to the red, green, and blue illumination required to produce perception of the desired color for that pixel.

RGB is sometimes referred to as the additive primaries, since monochromatic light is added together from these three primaries to produce the desired color. For printing applications, pigments typically subtract light, and colors are reproduced by a combination of cyan (red absorbing), yellow (blue absorbing), and magenta (green absorbing) pigments in what is known as the CYM system. CYM is sometimes referred to as the subtractive primaries. In printing applications, black is often added as a fourth primary, resulting in the CYMK system. Whether dealing with film, television cameras, color printing, or computer displays, limited numbers of primaries have been used historically in part because of the costs associated with adding additional colors.

The basic RGB color system has been in use since about the 1930's, and largely remains as the standard for color image representation. In part, this is because encoding and displaying images in RGB is an efficient way to compress color information. In RGB, only three numbers (corresponding to red, green, and blue intensity) need to be used, avoiding the need to store a large quantity of information to describe n-dimensional color spectrum intensity.

In practice, however, there are colors which can be perceived by the human eye that cannot be reproduced in a RGB system. Various efforts have been made to optimize the wavelength choices of the RGB primaries used, and some devices allow adjustments in how colors are converted into the RGB system. Nonetheless, most devices have a limited range of colors which can be reproduced, and many difficulties in rendering realistic appearing color remain. Some individuals find that colors reproduced on their computer monitors, televisions, and printers fail to accurately model true life.

Problems with color fidelity in RGB are particularly pronounced when color metamerism is considered. Color metamerism is defined as the situation when two samples match in color under one condition, but fail to match under another condition. Although color metamerism can be caused by various factors, a significant factor is differences in illumination. For example, two objects having different spectral reflective curves may appear to be the same color under some lighting conditions and appear to be different colors under other lighting conditions. These difficulties are particularly pronounced in the field of fine art reproduction. Fine art works can be created in a variety of different mediums, each of which has unique spectral reflectance curves. Typical printing inks cannot match these spectral reflectance curves, and thus fail to provide accurate reproduction. Similarly, when images are captured in RGB format, the resulting image is only an accurate reproduction of the original in the particular lighting conditions for which the capture was obtained. The RGB encoded image will not accurately match the original when the original is viewed under differing lighting conditions.

### SUMMARY

It has been recognized that it would be advantageous to develop an enhanced system for capturing and displaying high quality color.

Briefly, and in general terms, the invention is directed to rich color image processing techniques. In one embodiment of the present invention, rich color image processing can be performed within an optical path of an imaging device. An array of tunable optical filter elements is disposed within the optical path. A light beam is propagated into the optical path and impinges upon the array of tunable optical filter elements. The tuning of the optical filter elements can be adjusted during an image dwell time to define an array of individually color controlled pixels within the light beam. The method can be used, for example, to capture and display rich color images.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a graph of the color spectrum of a hypothetical object;

FIG. 2 is a graph of an RGB encoded spectrum for the color spectrum of FIG. 1;

FIG. 3 is a block diagram of a system for rich color image processing in accordance with an embodiment of the present invention;

FIG. 4 is a graph of a color spectrum and tunable optical filter used for capture in accordance with an embodiment of the present invention;

FIG. 5 is a graph of a color spectrum and capture of an optical spectrum using 9 different predefined discrete color frequencies in accordance with an embodiment of the present invention;

FIG. 6 is a graph of a rich color spectrum captured in accordance with an embodiment of the present invention;

FIG. 7 is a block diagram of is a block diagram of a system for rich color image processing in accordance with an embodiment of the present invention;

FIG. 8 is a flow chart of a method of processing a rich color image within an optical path of an imaging device in accordance with an embodiment of the present invention;

FIG. 9 is a flow chart of a method of rich color image processing in accordance with an embodiment of the present invention;

FIG. 10 is a graph of a rich color information encoded in accordance with an embodiment of the present invention; and

FIG. 11 is a graph of a color spectrum reconstructed from rich color information in accordance with an embodiment of the present invention.

### DETAILED DESCRIPTION OF EXAMPLE EMBODIMENT(S)

Reference will now be made to the exemplary embodiments illustrated, and specific language will be used herein to describe the same. It will nevertheless be understood that no limitation of the scope of the invention is thereby intended.

As discussed above, most color imaging systems encoded images into RGB. Although some capture systems are known which use four primaries (that is, color spectrum intensity is measured at four different optical frequencies), the end image is still compressed into RGB encoding. Similarly, although some printers use 4 or 6 different ink colors to attempt to provide good color matching (due to the difference between additive color processing in a display versus subtractive color processing in ink pigments), the source image still has the lower resolution of RGB encoding. It has been recognized that several limitations in RGB systems exist. For example, the widely used 1931 CIE and 1964 CIE color spaces are based on averaging experimental results on a small number of observers. In these tests, however, it was noted that individuals can vary widely in their color perception. For example, in one color matching test, an individual is asked to adjust the intensity of three monochromatic red, green, and blue primary light sources to reproduce a monochromatic exemplar. Individuals can have large variations in the proportions of red, green, and blue required to match the exemplar. Hence, individuals whose color perception deviates from the average will fail to perceive an RGB encoded image as having the correct colors. Furthermore, some exemplar colors cannot be matched by standard primary colors.

More serious difficulties with the RGB color system exist for individuals with anomalous color vision. Variations in the genes for the retinal pigments of the cone cells can cause the response sensitivity of the cone cells to be shifted from the nominal value. In extreme cases, these shifts can cause color blindness. Approximately 8% of males have some degree of color blindness. Conversely, studies have shown that as many as 50% of females may have more than three different types of cone cells, resulting in a different color perception than those with only three types of cone cells. For these male and female individuals, images encoded in RGB provide even less realistic color than for individuals with normal cone cells.

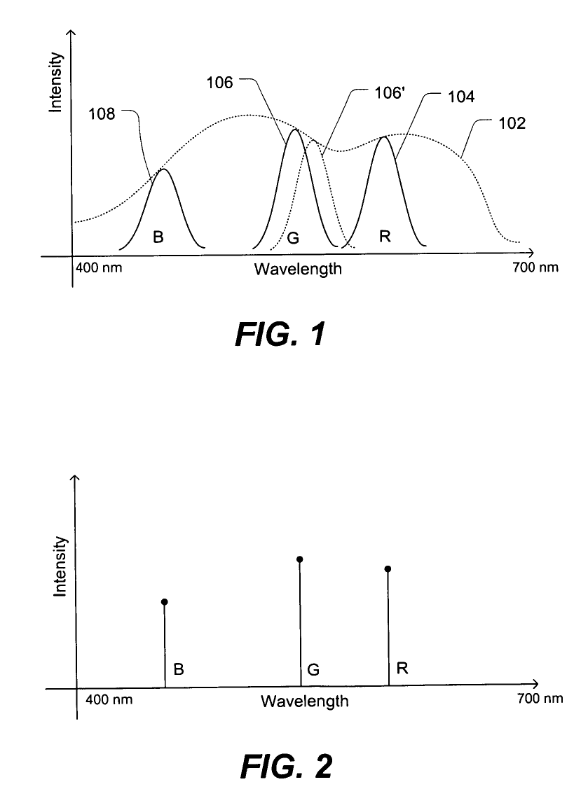

For example, FIG. 1 illustrates a color spectrum 102 of a hypothetical object. Superimposed over the color spectrum are (not to scale) representations of the response curves for the long wavelength “red” 104, medium wavelength “green” 106, and short wavelength “blue” 108 cones in the human eye. The resulting color is thus encoded by the visual system into three values representing the intensity measured by the red, green, and blue cones.

RGB color systems attempt to encode the color spectrum in a similar manner, and the resulting encoded spectrum is illustrated in FIG. 2. Note that much of the detailed color spectrum information is lost. When reproduced, for example in a computer monitor, monochrome color at the red, green, and blue wavelengths stimulates the cones similarly to the original spectrum, resulting in perception corresponding to the original color spectrum. Perfectly monochrome color is not required, and sometimes the red, green, and blue sources have relatively broad spectrums.

Now, consider an individual with anomalous color vision for whom the sensitivity of the green cones is shifted slightly longer in wavelength as shown by the anomalous response curve 106′. Since the color spectrum intensity is decreasing in that direction, the anomalous individual's green cones will produce a smaller response than a normal individual. When the spectrum is encoded in standard RGB, and then reproduced, the resulting green output is correctly matched for normal individual, but is unlikely to be correct for the anomalous individual. The amount of green stimulation received by the anomalous individual may be too large or too small, depending on the spectral characteristics of the green primary used. This can result in the anomalous individual perceiving poor color fidelity.

In short, this problem occurs because RGB encoding throws away much of the available color spectrum information. For the example color spectrum 102, there is a slight peak between blue and green and a slight dip between green and red which is lost when the spectrum is encoded into RGB. If everyone's cones responded exactly the same, this lost information would be of little consequence. But, since there is individual to individual variation in color perception, this lost information results in lost color fidelity.

Somewhat analogous to the problem of anomalous individuals, variations in lighting conditions also can cause significant variations in perceived color. For example, if images were always viewed in the same lighting conditions (e.g., a standardized combination of red, green, and blue light), metamerism would be reduced. But, variations in illumination conditions are difficult to avoid. Because color matching difficulty is caused, in part, by the complex color spectrums of objects, capturing additional color information can help to reduce these difficulties.

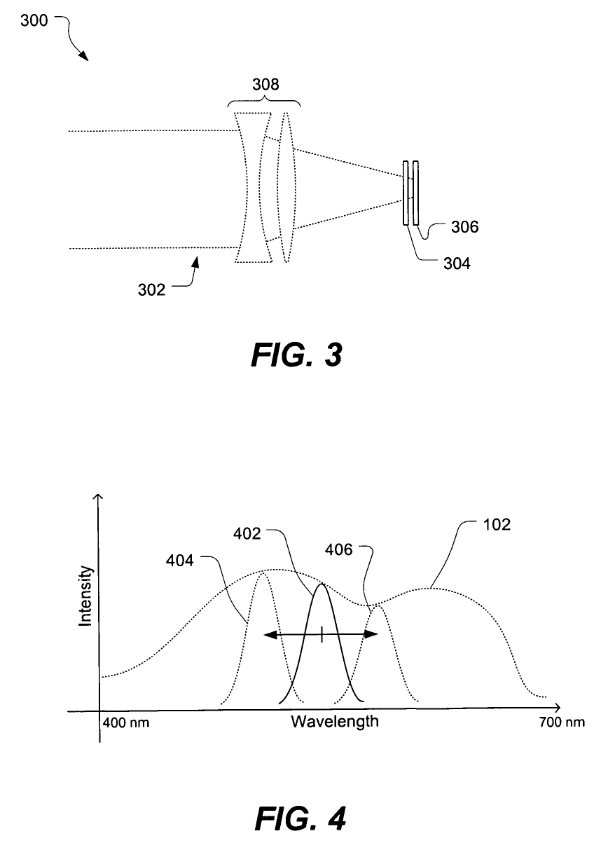

Rich color image processing can enhance the fidelity of color systems by capturing and reproducing more color spectrum information as compared to RGB systems. FIG. 3 illustrates a system for rich color image processing in accordance with one embodiment of the present invention. The system can be used, for example, to capture rich color images. The system, shown generally at 300, includes an optical subsystem configured to propagate a light beam along an optical path 302. For example, the optical subsystem can include optics 308, such as a camera lens or scanner bed. Disposed within the optical path is an array 304 of optical filter elements which define an array of pixels. The optical filter elements can be arranged, for example, in a linear array (e.g., in a scanner) or in two-dimensional array (e.g., in a camera).

The pixels are defined by the array of optical filter elements as will now be explained. Each optical filter optically color filters a spatial region within the optical path. For example, a 10×10 array of optical filter elements can be positioned to extend perpendicular to the axis of the optical path to define an image plane of 100 pixels. Of course, much larger arrays than this example can also be used. Optical color filtering selectively transmits or reflects a portion of the spectrum of the light beam impinging on the array. For example, a transmissive optical filter may be tuned to only pass orange-colored light, in which case light at wavelengths corresponding to other colors will be attenuated by the optical filter. The optical filter elements are tunable over a range of optical frequencies. For example, the optical filter elements can be tunable Fabry-Perot interferometers. Fabry-Perot interferometers, as are known in the art, comprise a pair of reflective or partially reflective plates separated by a small distance comparable to the wavelength of light. Constructive and destructive interference between reflections from the two plates result in selective reflection from and/or transmission through the interferometer.

The system also includes an array of sensing elements 306 disposed substantially proximate to the array of optical filter elements, at least one sensing element associated with each optical filter element. The array of sensing elements senses optical intensity information over the range of optical frequencies to capture a rich color image. For example, the sensing elements can be charge coupled devices as is known in the art.

The system can include a plurality of tuning control circuits (not shown) coupled to the optical filter elements to control the color tuning frequency of the optical filter elements. For example, Fabry-Perot interferometers can be constructed using a pair of spaced reflector plates and tuned by piezoelectrically varying the spacing between the reflector plates. Each tuning control circuit can control a single optical filter element, or can control a plurality of optical filter elements. During capture of a rich color image, the color tuning frequency can be tuned to a plurality of discrete color tuning frequencies, or the color tuning frequency can be swept over a continuous range of color tuning frequencies.

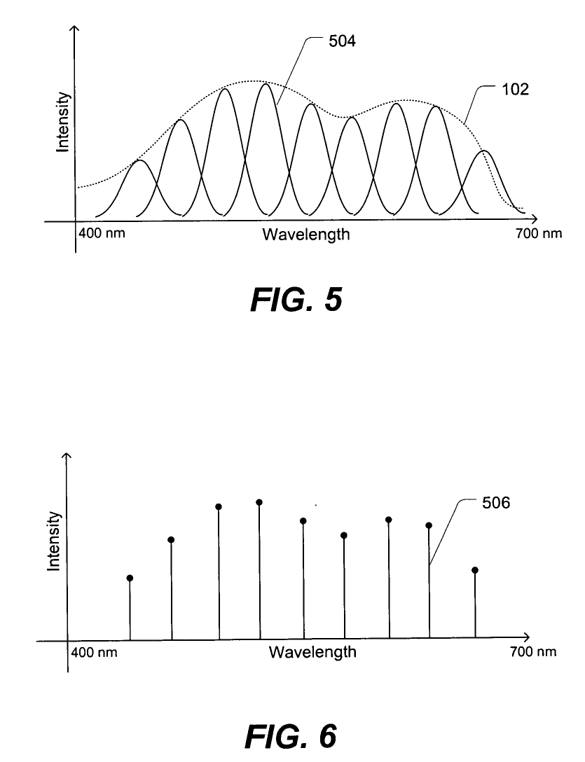

For example, using the system 300, rich color information can be captured as illustrated in FIG. 4 in accordance with an embodiment of the present invention. A tunable optical filter element can be tuned in frequency to shift the response over a range of optical frequencies. For example, a tunable optical filter can have a response 402 corresponding to a green primary color, and can be tunable below 404 and above 406 the green primary color to allow measurements of an optical spectrum 102 at those optical frequencies. Samples of the optical intensity can thus be obtained by the sensing elements at a plurality of discrete frequencies or over a range of continuous optical frequencies. For example, the optical filter element can be tuned to several different discrete optical frequencies, and optical intensity sensed at each frequency. FIG. 5 illustrates rich color image capture of an optical spectrum 102, where the optical filter elements are tuned to 9 different predefined discrete color frequencies 504. The resulting rich color spectrum is shown in FIG. 6, and is represented as nine optical intensity values 506 corresponding to the 9 predefined color frequencies. In comparing FIG. 6 to FIG. 2, it can be seen that the rich color image provides improved fidelity to the original optical spectrum. Of course, other predefined color frequencies can be used as well, including for example standard RGB primaries, emerald (blue-green color of approximately 500 nm), a group of six frequencies in the visible band, or a combination of visible frequencies and frequencies in the infrared band and/or ultraviolet band.

Alternately, the optical filter element can be swept over a continuous range of frequencies (an optical bandwidth) while the optical intensity is integrated.

Rich color information can also be captured by determining the slope (the first derivative of intensity with respect to frequency or wavelength) of the optical spectrum, the curvature (second derivative of intensity with respect to frequency or wavelength) of the optical spectrum, and higher (third, fourth, etc.) derivatives of intensity with respect to frequency wavelength. For example, the slope of the optical intensity can be determined by differentiating the sensor output as the optical frequency of the tunable optical filter is swept. Alternately, the slope can be estimated from samples of the optical intensity taken at several different frequencies. The curvature of the optical intensity spectrum can be similarly determined. Various other techniques for estimating the slope, the curvature and higher derivatives will occur to one of skill in the art in possession of this disclosure.

The optical filter elements can be configured to tune over a wide frequency range, for example spanning the entire visual band and extending into the infrared and/or ultraviolet bands. Alternately, optical filter elements can be configured to tune an optical bandwidth that covers a portion of the visible spectrum.

For example, the array of optical filter elements can be partitioned so that subsets of optical filter elements are assigned to cover different frequency ranges. The array can include interleaved subsets of optical filter elements assigned to a red range, green range, and blue range in a geometric pattern similar to a Bayer mosaic. Each subset of optical filter elements can be configured to tune above and below the corresponding primary color frequency to obtain optical intensity and derivatives of intensity with respect to wavelength at the primary color frequencies. The resulting combination of RGB intensity values and RGB derivatives thus provides rich color information.

The system 300 may include an image encoder (not shown) coupled to the array of sensing elements and configured to encode the rich color image into a predefined format. For example, rich color information can be stored as an array of pixel values having rich color information as described in further detail below. Various compression algorithms can also be applied to reduce the size of the rich color image as will occur to one of skill in the art having possession of this disclosure. For example, rich color information can be efficiently stored as intensity plus derivatives of intensity versus frequency (or equivalently wavelength) as discussed further below.

The system 300 provides several benefits. As discussed previously, by maintaining higher resolution color spectral information, improved fidelity is obtained as compared to an RGB system. The array of tunable optical filter elements allows for economical capture of color spectral information over a plurality of color frequencies because the individual optical filter elements can be tuned. This is in contrast to previous systems which use fixed tuned filters, for example, in the form of a Bayer matrix. Another advantage of the system is increased color resolution can be obtained because rich color spectral information can be obtained for each pixel. This is in contrast to previous systems where individual pixels are assigned a single color, and superpixels are created by combining multiple individual pixels. For example, in the Bayer matrix, four pixels (two green, one red, and one blue) are combined to form an RGB superpixel.

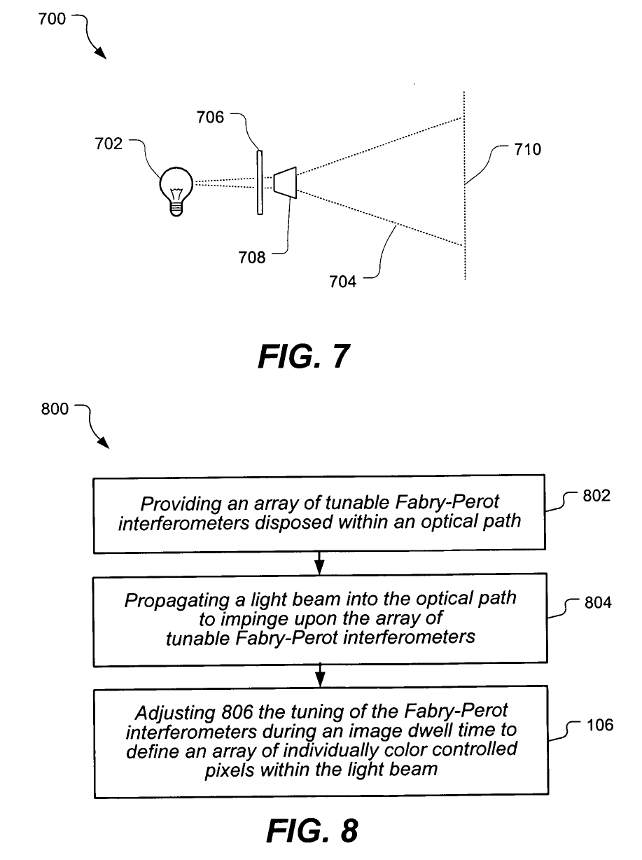

FIG. 7 illustrates a system for rich color image processing in accordance with a second embodiment of the present invention. The system can be used, for example, to display rich color images. The system, shown generally at 700, includes a light source 702 disposed within an optical path 704. The system also includes an array of Fabry-Perot interferometers 706 disposed within the optical path. The Fabry-Perot interferometers provide color filtering. Each Fabry-Perot interferometer in the optical path is configured to be individually tunable during operation of the system to define an array of individually color controlled pixels. The system also includes an optical subsystem 708 disposed within the optical path and configured to project the array of individually color controlled pixels onto a display surface 710 to form a rich color image.

Various light sources 702 are suitable for use in embodiments of the present invention. For example, the light source can be a cold cathode fluorescent lamp, an incandescent lamp, light emitting diodes, a laser, and the like. It is preferable that the light source is a broad spectrum source, since this provides a broad range of potential colors for the pixels in the rich color image, although light sources having discrete emission spectrum can also be used.

The optical subsystem 708 can include a projector lens to provide a rich color projection system. Alternately, the optical subsystem can be configured to form the image on a display surface which is integral to the system, for example in the form of a computer monitor.

Turning attention to the array of Fabry-Perot interferometers 706, the optical path can be configured to provide for transmission through the array as illustrated. In this case, each Fabry-Perot interferometer provides a tunable bandpass filter, passing a desired color through and attenuating other colors. Hence, when broad spectrum light (e.g., white light) impinges upon the array, the individual elements can be tuned to a selected color, which passes through the array to create the individually color controlled pixel.

Alternately, the optical path can be configured to provide for reflection from the array of Fabry-Perot interferometers. The Fabry-Perot interferometers can be tuned to a desired color to create the desired reflected pixel color. As yet another alternative, the optical path can be configured to use multiple arrays and combinations of reflection and transmission.

The system 700 can include a plurality of tuning control circuits (not shown) to control the tuning of the Fabry-Perot interferometers, for example as described above. Each tuning control circuit can be coupled to a single Fabry-Perot interferometer, or to a group of Fabry-Perot interferometers. The tuning control circuits can be configured to tune a color tuning frequency corresponding to a desired pixel color, or can be configured to tune over a range of color tuning frequencies to reproduce a desired color spectrum, as described further below.

As discussed above, the ability of the system 700 to project a rich color image provides benefits in the form of improved color fidelity. A wider color gamut can be provided by the system as compared to a RGB display. Hence, rich color images can be displayed with high resolution color spectrum for the individual pixels. This will provide higher fidelity color, especially when viewed by individuals with anomalous color vision. This system can also provide improved color fidelity for RGB encoded images, since the wider color gamut can help to ensure that the correct intended pixel colors are obtained.

A method of processing a rich color image within an optical path of an imaging device is illustrated in flow chart form in FIG. 8 in accordance with a third embodiment of the present invention. The method, shown generally at 800, includes providing 802 an array of tunable Fabry-Perot interferometers disposed within the optical path. The method also includes propagating 804 a light beam into the optical path to impinge upon the array of tunable Fabry-Perot interferometers. For example, a light beam can be propagating into the optical path using a light source, camera lens, or scanner bed, as described above. The method also includes adjusting 806 the tuning of the Fabry-Perot interferometers during an image dwell time to define an array of individually color controlled pixels within the light beam.

The method 800 can be used to capture a rich color image as will now be described in further detail. Capture of the image occurs during the dwell time, which can be viewed as analogous to shutter speed in a camera. The light beam can be propagated into the optical path to form an image within the optical path, for example on a sensor array. The sensor array can sample optical intensity of the light beam at a plurality of positions to define a rich color image. One or more sensors can be positioned to correspond to each of the individually color controlled pixels.

During the dwell time, the tuning of the Fabry-Perot interferometers can be coordinated with the sampling of the optical intensity to enable the capture of rich color information for each individually color controlled pixel. For example, each Fabry-Perot interferometer can be sequentially tuned to a plurality of discrete optical frequencies during the dwell time, and optical intensity sensed at each of the plurality of discrete optical frequencies. As another example, each Fabry-Perot interferometers can be tuned over a band of optical frequencies and the optical intensity sampled during the sweeping. Optical intensity can be integrated during the sweep time (to obtain an optical intensity integrated over the bandwidth) or differentiated during the sweep time (to obtain an optical intensity slope), as discussed above.

Different Fabry-Perot interferometers can be tuned differently during the dwell time. For example, some interferometers can be assigned to tune a red range, some to tune a green range, and some to tune a blue range as described above.

As discussed above, lighting conditions also have a large effect on perceived colors. Hence, the method can also be used to characterize illumination conditions, for example by capturing rich color images for both a scene being photographed and the lighting source.

For example, one approach to providing improved color fidelity is to perform rich color capture of known color calibration standards under the same illumination conditions as the image to be captured. This allows characterization of the illumination conditions, allowing later correction of captured images for different illumination conditions.

The method 800 can also be used to project rich color images as will now be described in detail. A collimated light beam can be propagated into the optical path. For example, the light beam can be white light, having energy of a wide range of optical frequencies. The light beam impinges upon the Fabry-Perot interferometer array and is optically filtered by the array to define an array of individually color controlled pixels. The light beam is then projected onto a display surface, for example using a projector lens as discussed above.

The tuning of the Fabry-Perot interferometers is adjusting during an image dwell time to create the particular color for each pixel. Dwell time is thus analogous to the video frame interval in a RGB system. The tuning of the Fabry-Perot interferometer can be adjusted in various ways during the dwell time. For example, the Fabry-Perot interferometers can be tuned to a particular frequency to result in a particular color for the pixels which is held constant during the image dwell time. A more complex spectrum can be created by sweeping or stepping the tuning of the Fabry-Perot interferometers during the image dwell time. For example, to reproduce a full color spectrum for each pixel, the individual Fabry-Perot interferometer can be swept over the visible range, with the rate of sweeping adjusted versus frequency so that more time is spent at color frequencies having higher intensity. Similarly, the tuning can be stepped over a number of discrete frequencies, holding the tuning at each frequency for a variable amount of sub-dwell time to produce a desired color spectrum.

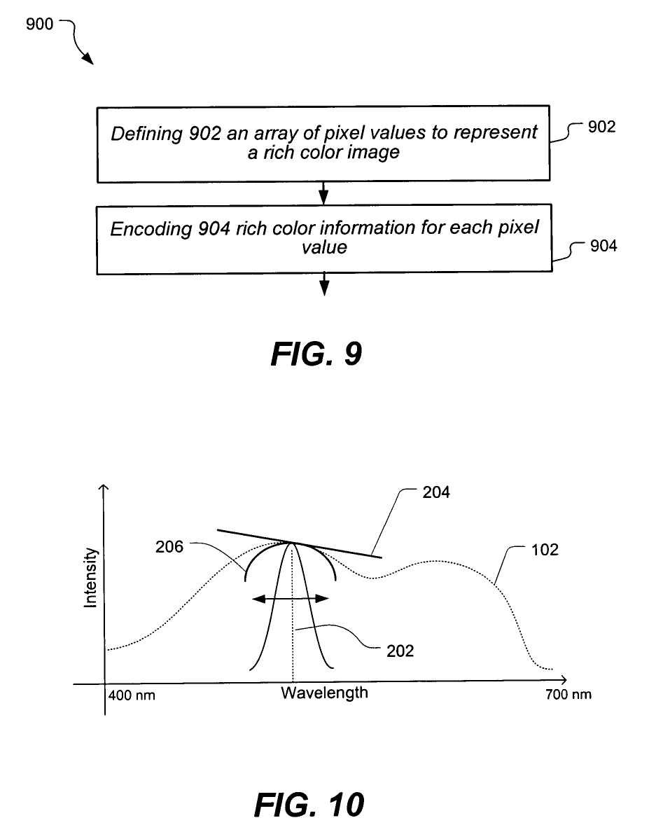

In accordance with a fourth embodiment of the present invention, a method of rich color image processing is illustrated in FIG. 9. The method includes defining 902 an array of pixel values to represent a rich color image and encoding 904 rich color information for each pixel value. The rich color information includes at least one spectral color intensity sample and at least one spectral color derivative sample. The spectral color intensity sample defines color intensity at a predefined color frequency, and the spectral color derivative sample defines a derivative (e.g. first, second, third, etc.) of spectral color intensity proximate to the predefined color frequency. The derivative can be computed with respect to either frequency or wavelength. For example, during capture, spectral color intensity and derivative values can be obtained at a plurality of predefined color frequencies as described above. More particularly, color slope values corresponding to the first derivative can be obtained as described above. FIG. 10 illustrates encoding of rich color information in accordance with an embodiment of the present invention. The intensity of the color spectrum 102 is sampled at a predefined color frequency 202. Color slope information is obtained in the vicinity of the predefined color frequency. For example, color slope can be encoded as the first derivative 204 and/or second derivative 206 and/or higher (third, fourth etc.) derivatives of the color intensity versus frequency. As another example, rich color information can include spectral color intensity samples corresponding to red, green and blue color primaries and spectral color slope samples corresponding to the slope of spectral color intensity in the vicinity of red, green and blue.

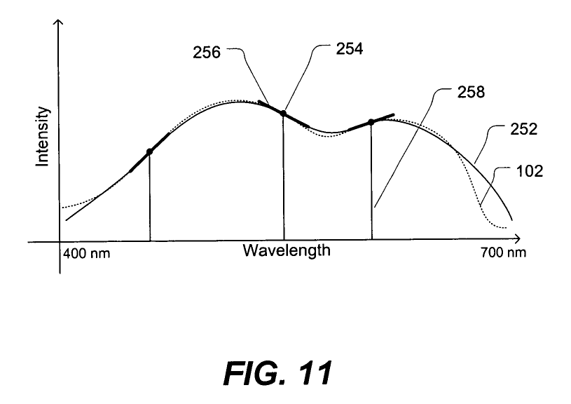

The method can include reconstructing a color spectrum from the rich color information. For example, as illustrated in FIG. 11 in accordance with an embodiment of the present invention, a color spectrum 252 can be reconstructed from rich color information samples having color intensity 254 and color slope 256 values defined at a plurality of predefined frequencies 258. The spectrum can be reconstructed, for example, by interpolation. The reconstructed spectrum provides a good approximation to the original optical spectrum 102. As more predefined frequencies are included and/or more derivatives are included in the rich color information, improved matching between the reconstructed spectrum and the original spectrum can be obtained. Reconstructing a color spectrum can be useful, for example, when converting from one color system to another color system, such as when converting from one set of color primaries to another.

Finally, the method can include capturing or displaying a rich color image, for example, as described above.

From the foregoing, it will be appreciated that rich color image processing in accordance with the described systems and methods can provide improved fidelity in captured and displayed images. Color spectrum information that is discarded by RGB systems can be captured, for example in digital cameras, and reproduced, for example in display systems. Rich color information can be represented by sampling the optical intensity at a plurality of discrete frequencies, and can include optical intensity slope information. Benefits of a rich color system can include improved color fidelity and realism, including reduced metamerism, and higher utility for individuals with anomalous color vision.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A system for rich color image processing comprising:
a) an optical subsystem configured to propagate a light beam along an optical path;
b) an array of optical filter elements disposed within the optical path to define an array of pixels, wherein
(i) each optical filter element optically color filters a spatial region within the optical path corresponding to a pixel of an image within the light beam and
(ii) each optical filter element is tunable over a range of optical frequencies; and
c) an array of sensing elements disposed substantially proximate to the array of optical filter elements, at least one sensing element being associated with each optical filter element, the array of sensing elements configured to sense optical intensity information over the range of optical frequencies to capture a rich color image.

2. The system of claim 1, wherein the optical filter element is a tunable Fabry-Perot interferometer.

3. The system of claim 1, wherein the optical subsystem comprises an optical component chosen from the group of optical components consisting of a camera lens and a scanner bed.

4. The system of claim 1, further comprising a plurality of tuning control circuits, each tuning control circuit coupled to at least one of the optical filter elements and configured to control a color tuning frequency of the at least one optical filter element.

5. The system of claim 4, wherein the tuning control circuits are configured to tune to a plurality of discrete color tuning frequencies during capture of the rich color image.

6. The system of claim 4, wherein the tuning control circuits are configured to tune over a continuous range of color tuning frequencies during capture of the rich color image.

7. The system of claim 1, wherein the array of sensing elements comprises a charge coupled device.

8. The system of claim 1, further comprising an image encoder coupled to the array of sensing elements and configured to encode the rich color image into a predefined format.

9. A system for rich color image processing comprising:
a light source disposed within an optical path;
an array of Fabry-Perot interferometers disposed within the optical path, each Fabry-Perot interferometer configured to be individually tunable during operation of the system to define an array of individually color controlled pixels; and
an optical subsystem disposed within the optical path configured to project the array of individually color controlled pixels onto a display surface to form a rich color image.

10. The system of claim 9 wherein the light source is selected from the group of light sources consisting of a cold cathode fluorescent lamp, a light emitting diode, a laser, and an incandescent lamp.

11. The system of claim 9 wherein the optical subsystem comprises a projector lens.

12. The system of claim 9 wherein the display surface comprises a monitor viewable surface.

13. The system of claim 9 further comprising a plurality of tuning control circuits, each tuning control circuit coupled to at least one of the Fabry-Perot interferometers and configured to control a color tuning frequency of the at least one Fabry-Perot interferometer.

14. A method of rich color image processing comprising:
a) defining an array of pixel values to represent a rich color image; and
b) encoding rich color information for each pixel value wherein the rich color information for each pixel comprises:
i) at least one spectral color intensity sample defining a color intensity at a predefined color frequency, and
ii) at least one spectral color derivative sample defining a derivative of color intensity proximate to the predefined color frequency.

15. The method of claim 14, wherein the at least one spectral color derivative samples comprises a first derivative of color intensity with respect to color frequency.

16. The method of claim 14, wherein the rich color information further comprises a plurality of spectral color intensity samples at a plurality of predefined color frequencies and a plurality of spectral color derivative samples at the plurality of predefined color frequencies.

17. The method of claim 16, wherein the plurality of predefined color frequencies includes an optical frequency selected from the near-visible frequencies consisting of infrared and ultraviolet.

18. The method of claim 14, further comprising capturing a rich color image.

19. The method of claim 14, further comprising displaying a rich color image.

20. The method of claim 14, further comprising reconstructing an optical spectrum from the rich color information.
